(19) United States
(12) Patent Application Publication
(10) Pub. No.: US 2001/0045037 A1
(43) Pub. Date: Nov. 29, 2001

(54) PATIENT CARE AND MEDICAL ALERT SYSTEM

(76) Inventors: LESLIE G. BANK, CLOSTER, NJ (US); BARBARA CAMPBELL, GREENWICH, CT (US)

Correspondence Address: CUMMINGS & LOCKWOOD, FOUR STAMFORD PLAZA, P O BOX 120, STAMFORD, CT, 069040120

(21) Appl. No.: 09/363,872

(22) Filed: Jul. 29, 1999

Related U.S. Application Data
(63) Continuation-in-part of application No. 08/956,749, filed on Oct. 23, 1997, now abandoned.

(51) Int. Cl. G09F 7/04

(52) U.S. Cl. 40/621

(57) ABSTRACT

A patient care and medical alert system for a patient care facility is disclosed which includes a message board adapted and configured to be mounted on a wall associated with a room of the patient care facility. The message board has a front surface defining a permanent message area and a temporary message area. The permanent message area contains indicia identifying the room. A set of message bearing members are provided and each contains distinct indicia relevant to the care of a patient located with the room adjacent the message board. The message bearing members each include structure for effecting the removable attachment thereof to the front surface of the message board within the temporary message area.

### BACKGROUND OF THE INVENTION

1. Field of the Invention

The subject invention relates to a patient care and medical alert system for a patient care facility such as a hospital, and more particularly, to a message board for displaying information relevant to the status, condition or needs or a patient located within a particular hospital room.

2. Background of the Related Art

In hospitals, it is commonplace to provide a chart at the foot of a patients bed to facilitate the recordation of the patient's vital statistics and to display patient care instructions, such as, for example, medicament dosages, or warnings, such as, for example, fluid restrictions or a preferred location for effecting venipuncture. Hospital charts can also display information as to the proper configuration or orientation of a patient's bed such as, for example, the use of fall prevention apparatus and the proper elevation of the head or foot of the patient's bed.

Patient care instructions are commonly handwritten and can thus be difficult to read and understand. In addition, the care instructions may have been changed a number times during the course of a patient's hospital stay, as the patient's condition changes, creating a confusing array of both useful and outmoded information on the chart.

During the course of a day, in attending to a patient's needs, it is necessary for a nurse or attendant to periodically enter a patient's room, examine the patients chart, and determine whether the patient requires particular care or services. This method of review is time consuming and intrusive to the patient's privacy, particularly during evening hours. Following a shift change, when it is necessary for a nurse coming on shift to become versed with each patient's care instructions, this inefficiency becomes more acute.

Clearly there is a need for a more effective and efficient way in which to display patient care instructions, as well as medical warning relating to a patient's condition in a readily accessible and highly visible location associated with a hospital room.

### SUMMARY OF THE INVENTION

The subject invention is directed to a patient care and medical alert system which provides an effective and efficient way in which to display patient care instructions, vital statistics and medical warnings in a readily accessible and highly visible location associated with a patient's room. The system includes a message board mounted on a wall associated with a room in a patient care facility, such as, for example, a hospital, clinic or professional office. The message board is preferably mounted on an interior wall of the room adjacent the patient's bed, so as to be in clear view of an attending physician or nurse. Alternatively, the message board may be mounted an exterior wall of the room adjacent the doorway. The message board may also be placed in a bathroom associated with the patient's room.

The message board of the patient care and medical alert system of the subject invention has a front surface which defines a permanent message area and a temporary message area. The permanent message area contains indicia identifying the room. The rear surface of the message board is preferably provided with means for mounting the message board on a wall associated with the room, such as, for example, adhesive means for adhering the message board to a wall of the room.

In one embodiment of the subject invention the message board is hingedly attached to a cavity-bearing base, the cavity being of such dimension that one or more message bearing placards may be stored, therein. The rear surface of the cavity base (the surface most distal from the message board) is preferable provided with a means for mounting on a wall associated with the room, such as, for example, an adhesive such as foam tape and solastic adhesive.

The system further includes a set of message bearing members or in the form of rectangular placards each containing distinct indicia relevant to the care of a patient located with the room adjacent the message board. The message placards and the temporary message area of the message board are preferably both magnetized in such a manner so as to facilitate removable attachment of the message bearing placards to the front surface of the message board. Preferably, the message board is magnetized in such a manner so as to promote a predetermined aligned arrangement of the message bearing placards with respect to the message board. Preferably the message bearing placards and the message board bear magnetic fields oriented with respect to one another other such that the message bearing placards are attachable to the message board in only one orientation. Preferably the message board (and the magnetic fields which it bears) is oriented in the room such that magnetized message bearing placards will only attach to the message board in the one orientation which permits upright reading of the indicia on message bearing placards (i.e., the indicia are correctly oriented for conventional reading). Such embodiment prevents placing the placards in a manner such that they can be misread (such as a “6” being misread as a “9”). Such orientation function particularly is important in a hospital where information concerning a patient's status may be needed at a moment's notice, particularly in an emergency situation.

These and other features of the patient care and medical alert system of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the subject invention appertains will more readily understand how to make and use the patient care and medical alert system of the subject invention, preferred embodiments of the system will be described in detail herein below with reference to the drawings wherein:

FIG. 1 is an illustration of a room in a patient care facility as viewed from the hallway corridor with the patient care and medical alert system of the subject invention mounted on an interior wall of the room adjacent a patient's bed to display permanent information identifying the room and temporary care information and instructions relating to the patient located within the hospital room;

FIG. 2. is a front plan view of the message board of the patient care system of the subject invention with six different message bearing placards releasably attached to the temporary message area of the message board by magnetic attraction;

FIG. 3 is a cross-sectional view taken along line 3-3 of FIG. 2 illustrating the configuration of the frame which supports the message board;

FIG. 4 is an illustration of a room in a patient care facility as viewed from the hallway corridor with an alternative embodiment of the patient care and medical alert system of the subject invention mounted adjacent the door of the room to display permanent information identifying the room and temporary care information and instructions relating to the patient located within the hospital room;

FIG. 5. is a front plane view of the message board of the patient care and medical alerts system of FIG. 4 with six different message bearing placards releasably attached to the temporary message area of the message board and arranged in an aligned orientation; and

FIG. 6 is a front plan view of yet another embodiment of the message board of the patient care and medical alert system of the subject invention which includes two separate permanent and temporary message areas for use in a room occupied by two patients.

FIG. 7 is a front plane view of five different message bearing placards of various shapes that may find use in the present invention.

FIG. 8 is a cross-sectional view, taken along the 1-1′ line of FIG. 9, of an embodiment of the present invention permitting storage of the message bearing placards in conjunction with the message board.

FIG. 9 is a front plane view of a message board of an embodiment of the patient care and medical alert system of the present invention.

### DETAILED DESCRIPTION OF THE PREFERRED EMBODIMENTS

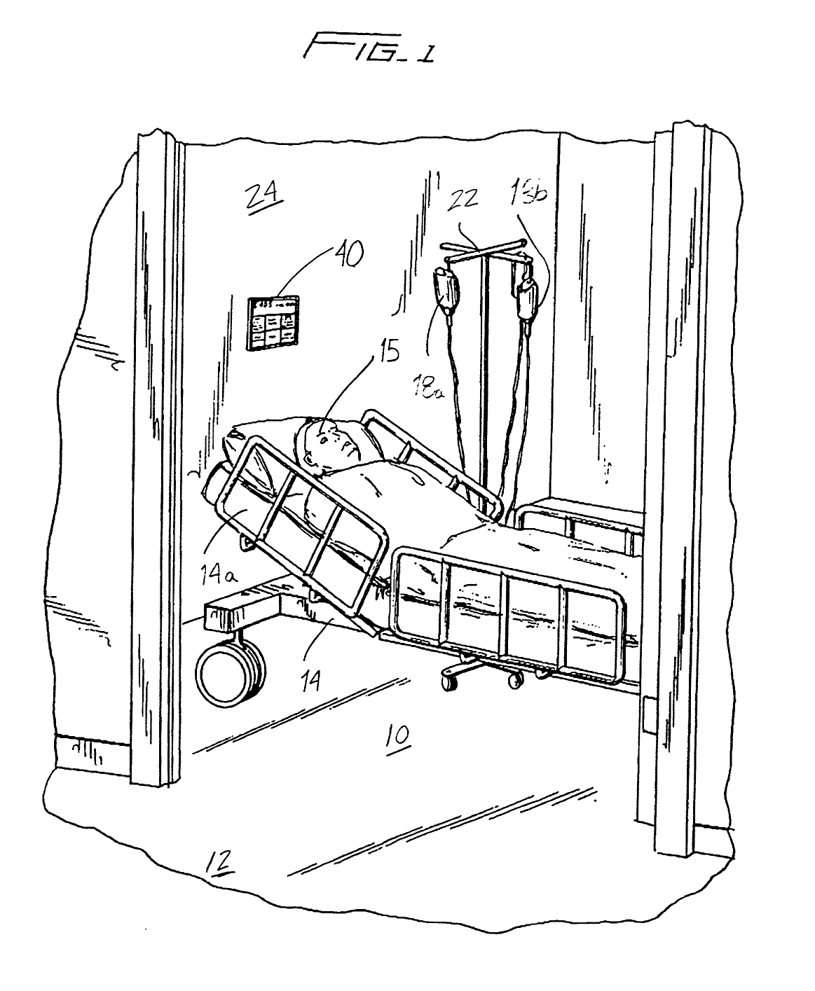

Referring now in detail to the drawings wherein like reference numerals identify similar structural elements of the patient care and medical alert system of the subject invention, there is illustrated in FIG. 1 a room 10 in a patient care facility 12, such as a hospital, in which a bed 14 is located. A patient 15 is positioned in bed 14 and the head portion 14a of the bed is elevated at an angle of approximately 30°. Bed rails 16 are operatively associated with bed 14 and are disposed in the upright position to prevent the patient 15 from falling from the bed. Two intravenous bags 18a and 18b and associated conduits 20a and 20b are supported on a cart 22 adjacent bed 14 for supplying vital fluids to patient 15.

In accordance with a preferred embodiment of the subject invention, a message board designated generally by reference numeral 40 is mounted on the interior wall 24 of the patient's room, adjacent the head portion 14a of bed 14. The message board 40 of the patient care and medical alert system of the subject invention is designed as a modular messaging system for displaying information identifying the room 10, as well as care instructions and medical warnings relating to the patient 15, in a highly visable location, so as to make patient care more efficient.

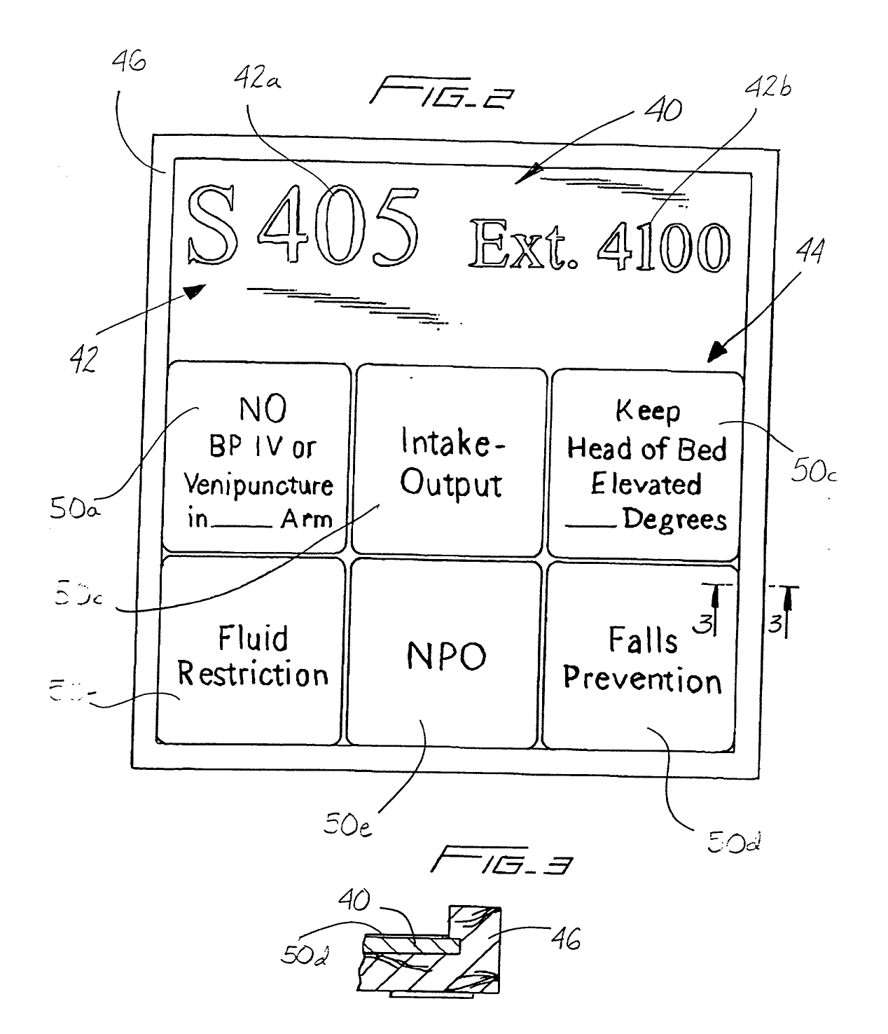

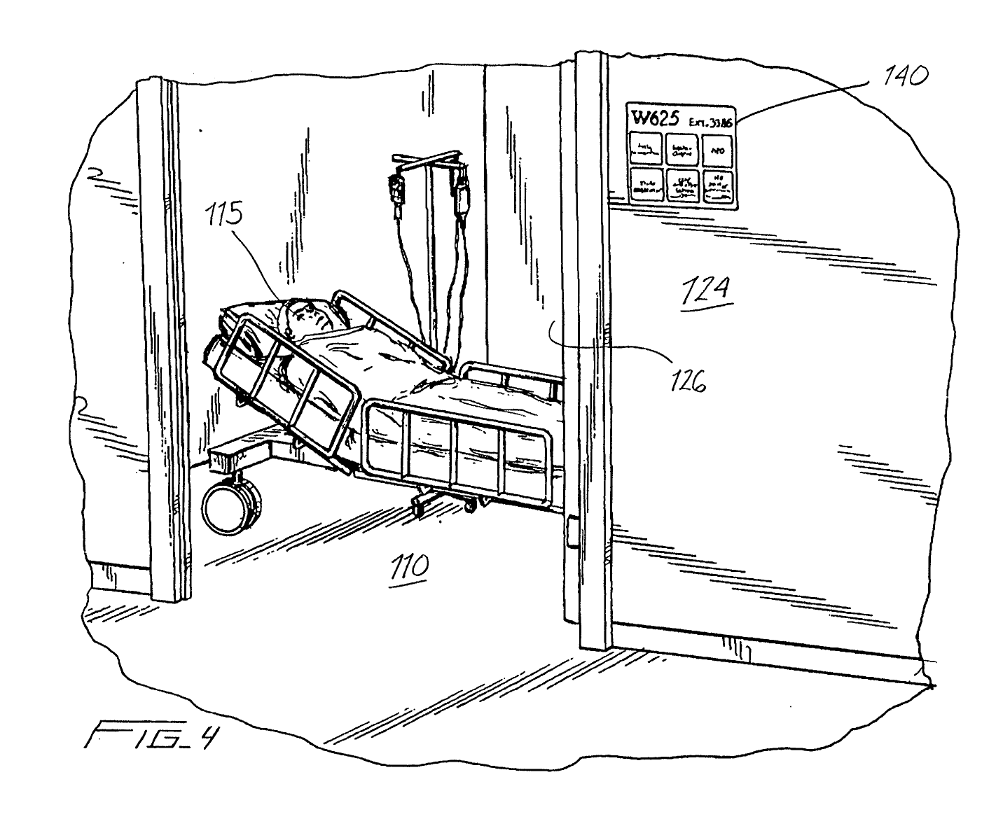

Referring to FIG. 2, the message board 40 of the patient care system of the subject invention defines a permanent message area 42 and a temporary message area 44. A frame 46, preferably fabricated from wood, supports the message board 40 and provides an aesthetically pleasing appearance. As illustrated in FIG. 3, adhesive tape is secured to the rear surface of the frame 46 to facilitate mounting of the message board 40 to a wall associated with the patient's room 10. Alternative means, such as conventional fasteners, may be employed to mount the message board in an appropriate location.

Referring again to FIG. 2, the permanent message area 42 includes indicia relating to the room 10 with which message board 40 is associated. As exemplified by the illustration, permanent message area 42 includes indicia 42a relating to the room number and wing, namely the alphanumeric expression “S405”, as well as indicia 42b relating to the telephone extension of the room, namely the phrase “Ext. 4100”. Other identifying information can also be provided in the permanent message area of message board 40, such as, for example, the specific care unit with which the room is associated, i.e., pre-natal, post-natal, intensive care, cardiac care, emergency room, etc.

With continuing reference to FIG. 2, the patient care system of the subject invention further includes a set of message bearing placards 50a-50f each having specific indicia thereon relating to the care of a patient located in a hospital room, or providing a specific medical alert relating to the patient's condition. Each of the message bearing placards 50a-50f is configured for releasable attachment within the boundaries of the temporary message area 44 of message board 40. In a preferred embodiment of the subject invention, the temporary message area 44 and each message bearing placards is magnetized to facilitate the releasable attachment of the message bearing placards to the message board.

Referring now to FIGS. 1 and 2, each of the message bearing placards has a distinct message imprinted thereon providing a particular patient care instruction or medical alert. For example, message placard 50a displays the instruction “Falls Prevention.” This instruction indicates to a nurse or orderly that the bed rail 16 of bed 14 must be in an upright and locked position to prevent the patient 15 from falling from the hospital bed. Message placard 50b displays the instruction “Fluid Restriction,” indicating to a nurse or orderly that the patient's diet should be restricted to certain fluids such as, for example, water. Message placard 50c provides the instruction “Intake-Output” which informs the nurse or orderly that the patient's food intake and output must be monitored. Message placard 50d provides instructions relating to the orientation of bed 14 and in particular provides the instruction “Keep Head of Bed Elevated_Degrees.” This message placard can be changed by the nurse or orderly by writing a particular degree of elevation in the blank space using a felt tip marker or the like. Since the placards are fabricated from a plastic material, the writing may be readily removed therefrom.

With continuing reference to FIG. 2, message placard 50e displays the message “NPO,” indicating to a nurse or orderly that a patient must not be given any food of drugs orally. Message placard 50f provides the message “NO BP, IV or Venipuncture in _Arm,” instructing a nurse that blood pressure should not be taken in a particular arm, nor should intravenous or venipuncture be given or performed in a particular arm, left or right. Message placard 50e can be changed by the nurse using a felt tip marker or the like. Alternatively, two different message placards can be provided as part of the patient care system, one indicating preferred treatment in the right arm the other indicating preferred treatment in the left arm.

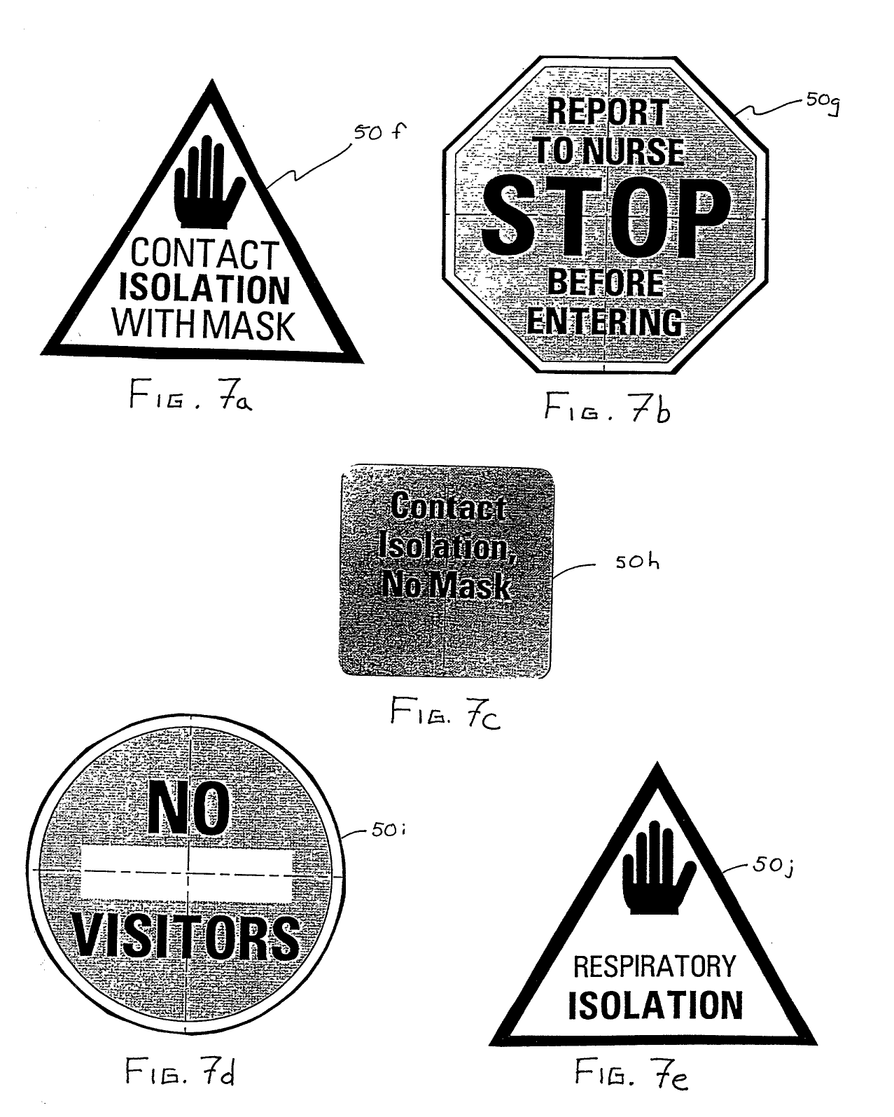

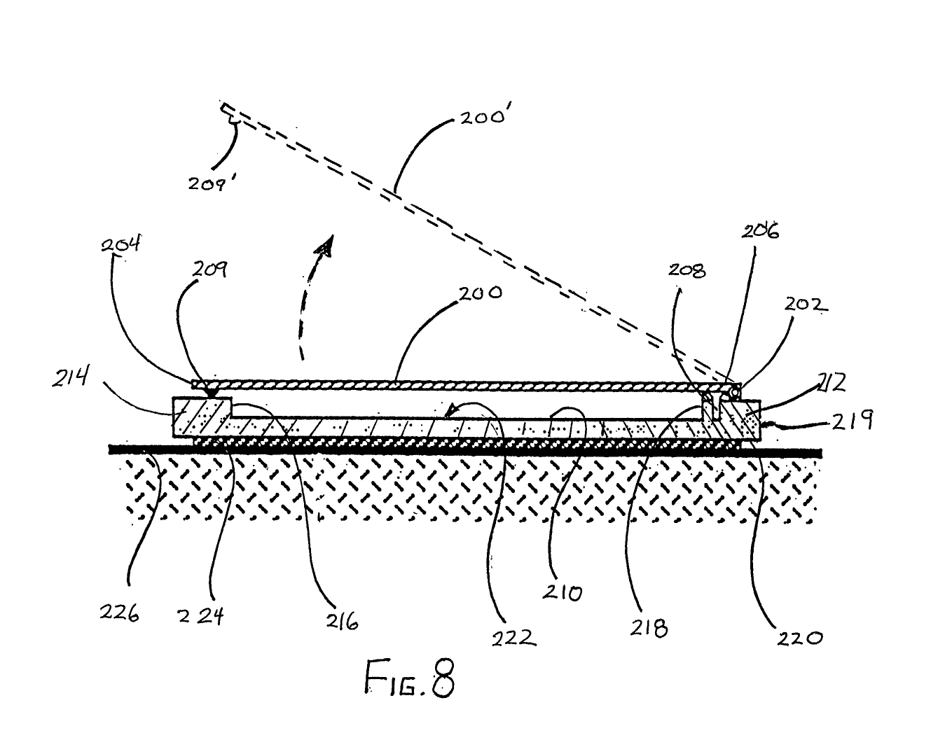

Now referring to FIG. 7a-7e, there is shown a number of other message placards that may find use in the present invention. As depicted in these figures, the placards themselves may take many different shapes, shapes which may signal the type of indicia thereon or which may signal a desired response. For example, message placard 50f is in the shape of a yield sign and indicates avoidance of contact without a mask. Message placard 50g is in the form of a stop sign and indicates that a person seeking entrance should “stop” before entering the room and report to a nurse. Message placard 50h is in the form of a curved square and indicates “Contact Isolation, No Mask.” Message placard 50i is in the form of a circle and indicates “No Visitors”. Message placard 50j, similar to message placard 50f, is in the shape of a yield sign (i.e., triangle) and indicates “Respiratory Isolation.”

In addition to the informational messages described hereinabove with reference to message bearing placards 50a-50j and those, the following is a list of medical alert messages that may be provided on other message bearing placards of the patient care system of the subject invention: No Visitors; Contact Isolation; Isolation Precautions; Contract Isolation; Strict Isolation; AFB Isolation; Varicella Precautions; Feeding Assistance Required; Latex Precaution; Seizure Precaution; Prosthesis—Dentures; Prosthesis—Glasses; and Prosthesis—Hearing Aide. In addition, the set of message bearing placards associated with the patient care system of the subject invention can include at least one blank magnetic message placard to permit additional hand written medical alert messages or patient care information.

It is envisioned that the patient care and medical alert system of the subject invention will also find use in a bathroom associated with a patient's room. In such instances, the following additional medical alert messages may be employed: Stool Guiac; 24 Hour Urine; and Strain Urine. In instances when a bathroom is shared by two patients in a common room, it is envisioned that the message board of the subject invention would have first and second permanent and temporary message areas, one for each of the patient's located in the shared room, as shown, for example, in FIG. 6. Each permanent message area contains the room number and other indicia identifying each patient in the room.

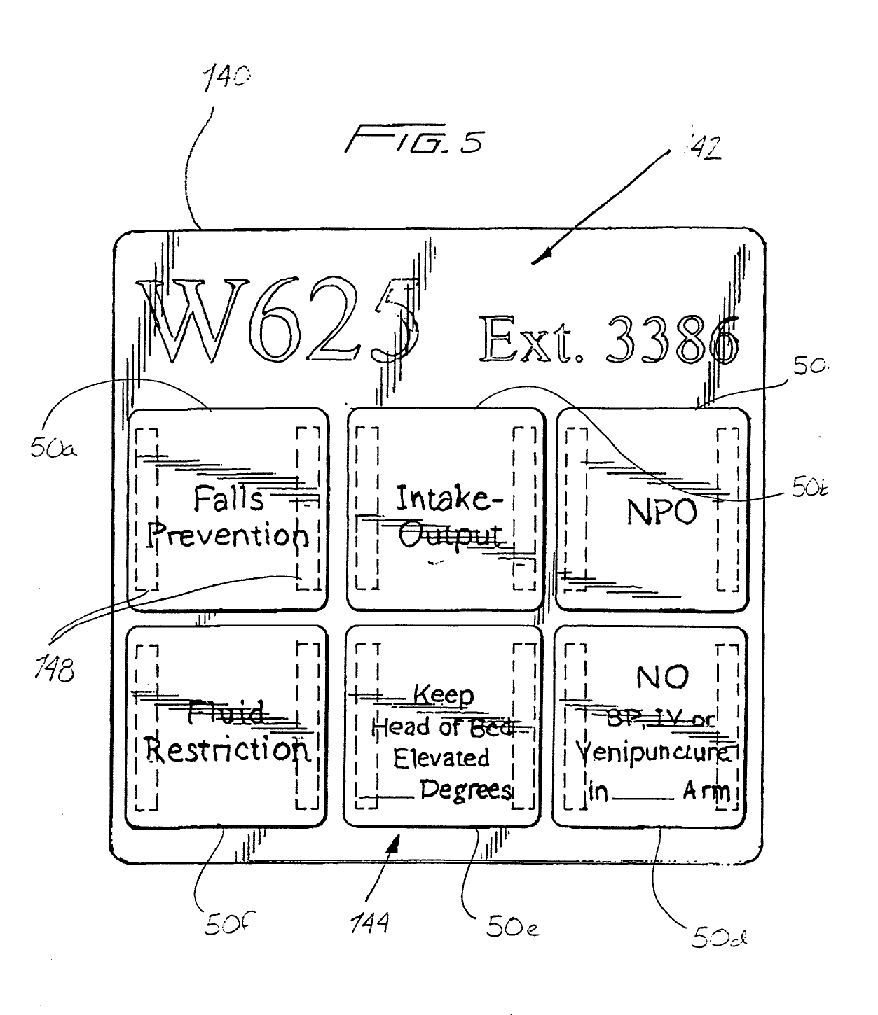

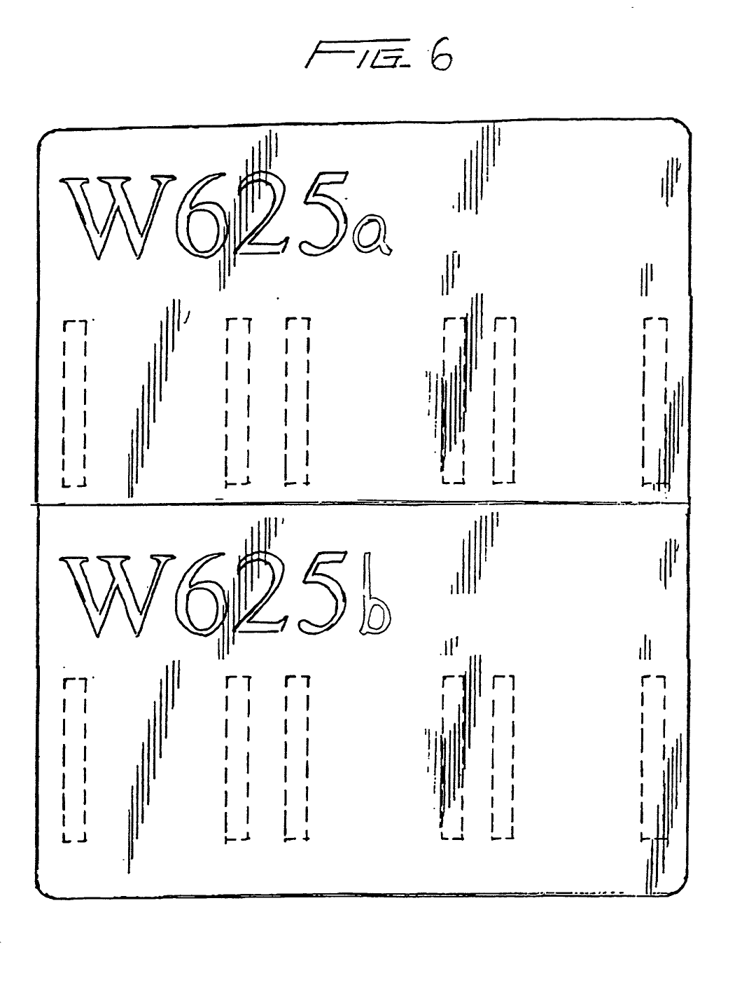

Referring now to FIG. 4, there is illustrated an alternative embodiment of the patient care and alert system of the subject invention, wherein a message board designated generally by reference numeral 140 is mounted on an exterior wall 124 of hospital room 110 adjacent the doorway 126 thereof to display information and medical alerts relating to the patient 115 located with the room 110. As best seen in FIG. 5, message board 140 is similar to message board 40 in that it includes a permanent message area 142 displaying identifying information relating to hospital room 110 and a temporary message area 144 for displaying a plurality of magnetic message bearing placards, such as, for example, message bearing placards 50a-50j.

The message board 140 differs from message board 40 however, in that it does not include a supporting frame, such a frame 46, and in that the temporary message area 146 is provided with one or more magnets 148 configured in such a manner so to promote a predetermined aligned arrangement of the message bearing placards 50a-50j.

It is envisioned that a unitary magnetized sheet may also be employed to provide the same result. A suitable magnetic sheet having an adhesive surface for attachment to the rear surface of the message board 140, as well as wall 124, is commercially available from 3M Corporation of Minneapolis, Minn., and is marketed under the tradename 467MP. It is envisioned that alternative methods of attachment, other than magnetic devices, may be employed to releasably attach the message bearing plates to the message board, such as, for example, a hook and loop type fastener mechanism.

It is envisioned that a set of message placards, with multiple copies of each placard, would be maintained in a centralized location, such as, for example, at a nurses station. Upon admitting a patient into the facility and determining the patient's needs, the specific message bearing plates relevant to such patient would be selected from the centralized location, and releasably secured to the message board associated with the patient's room, whether the message board is located within the room or outside of the room.

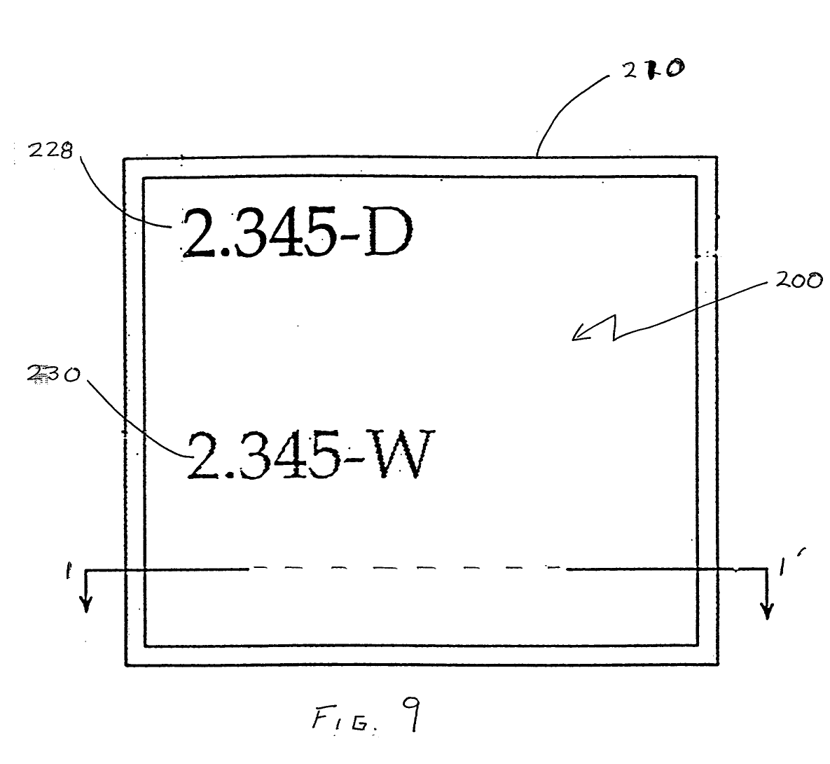

FIGS. 8 and 9 illustrate an alternative message display assembly embodiment of the present invention. As shown in FIG. 9 the assembly comprises a base portion 219 and face plate 200, which is formed at least in part from magnetically attractable material. The face plate may have one or more permanent message areas 228, 230, which as depicted indicate room numbers and position in the room (“D” for doorside, “W” for windowside). FIG. 8 sets forth a cross-sectional view of the message display assembly of FIG. 9 cut across the 1-1′ line. As illustrated face plate 200, having front portion 204 and back portion 202, is attached to base portion 219, having front portion 214 and back portion 212, through hinge 202 which is secured to base portion 219 by way of pin 208. Face place 200 is shown as having one or more cushions, or an elongated cushion, 204 which, when face plate 200 is hinged downward towards base portion 219, abuts front portion 210 of base portion 219. Base portion 219 is shown as having front surface 210, which extends up and over lateral walls 216 and 218, and rear surface 220. Base portion 219 defines a recessed area 222. Rear surface 220 is shown as operatively connected to supporting surface 226, e.g. a wall, by way of adhesive layer 224. Recessed area 222 is configured and dimensioned as to be able to store a number of message placards (which preferably are self adhering, most preferably through magnetic interaction, with faceplate 200).

Although the patient care and medical alert system of the subject invention has been described with respect to a preferred embodiment, it is apparent that modifications and changes can be made thereto without departing from the spirit and scope of the invention as defined by the appended claims.

What is claimed is:

1. A patient care and medical alert system for use in a patient care facility comprising:
a) a message board mounted on a wall associated with a room in a patient care facility, a front surface of said message board defining at least one permanent message area and at least one temporary message area, said at least one permanent message area containing indicia identifying said room; and
b) a set of message bearing members each containing distinct indicia relevant to the care or status of a patient located within said room associated with said message board, said message bearing members each including means for effecting the removable attachment thereof to said front surface of said message board within said at least one temporary message area.

2. A patient care and medical alert system as recited in claim 1, wherein said message board is mounted on an interior wall of said room.

3. A patient care and medical alert system as recited in claim 1, wherein said message board is mounted on an exterior wall of said room.

4. A patient care and medical alert system as recited in claim 1, wherein said means for effecting removable attachment of said message bearing members to said front surface of said message board comprises magnetic means operatively associated with said message board and said message bearing members.

5. A patient care and medical alert system as recited in claim 2, wherein said magnetica means are adapted and configured to promote a predetermined aligned arrangement of said message bearing members with respect to said message board.

6. A patient care and medical alert system as recited in claim 1, further comprising means for mounting said message board on a wall associated with said room.

7. A patient care and medical alert system as recited in claim 6, wherein said means for mounting said message board on a wall associated with said room comprises adhesive means provided on said rear surface of said message board for adhering to an exterior wall of said hospital room.

8. A patient care and medical alert system for use in a hospital comprising:
a) a message board having opposed front and rear surfaces, said rear surface having means for mounting said message board on a wall associated with a hospital room, said front surface defining a permanent message area and a temporary message area, said permanent message area containing indicia identifying said hospital room;
b) a set of message bearing members each containing distinct indicia relevant to the care or status of a patient located within the hospital room associated with said message board; and
c) means for effecting the removable attachment of said message bearing members to said front surface of said message board within said temporary message area.

9. A patient care and medical alert system as recited in claim 8, wherein said message board is mounted on an interior wall of said hospital room.

10. A patient care and medical alert system as recited in claim 8, wherein said message board is mounted on an exterior wall of said hospital room.

11. A patient care and medical alert system as recited in claim 8, wherein said means for effecting removable attachment of said message bearing members to said front surface of said message board comprises magnet means operatively associated with said message board and said message bearing members.

12. A patient care and medical alert system as recited in claim 11, wherein said magnet means are adapted and configured to promote a predetermined aligned arrangement of said message bearing members with respect to said message board.

13. A patient care and medical alert system as recited in claim 8, wherein said means for mounting said message board on a wall associated with said hospital room comprises adhesive means provided on said rear surface of said message board for adhering to said wall.

14. A patient care and medical alert system for use in a hospital comprising:
a) a message board mounted on a wall associated with a hospital room, a front surface of said message board defining a permanent message area and a temporary message area, said permanent message area containing indicia identifying said hospital room, and said temporary message area being magnetized; and
b) a set of message bearing members each containing distinct indicia relevant to the care or status of a patient located within the hospital room associated with said message board, said message bearing members each being magnetized to effect the removable attachment thereof to said front surface of said message board within said temporary message area.

15. A patient care and medical alert system as recited in claim 14, wherein said message board is mounted on an interior wall of said hospital room.

16. A patient care and medical alert system as recited in claim 14, wherein said message board is mounted on an exterior wall of said hospital room.

17. A patient care and medical alert system as recited in claim 14, wherein said means for mounting said message board on a wall associated with said hospital room comprises adhesive means provided on said rear surface of said message board for adhering to said wall.

18. A patient care and medical alert system as recited in claim 14, wherein said message board is magnetized in such a manner so as to promote a predetermined aligned arrangement of said message bearing members with respect to said message board.

19. A patient care and medical alert system as recited in claim 14, wherein said message board is provided with a decorative frame.

20. A patient care and medical alert system as recited in claim 14, wherein each message bearing member has an identical geometric configuration.

21. A patient care and medical alert system as recited in claim 1, wherein the distinct indicia of said message bearing members include areas on the surface of said message bearing member on which variable information is to be removably scripted thereon to complete the meaning of the indicia.

22. A patient care and medical alert system as recited in claim 8, wherein said distinct indicia of said message bearing members include areas on the surface of said message bearing member on which variable information is to be removably scripted thereon to complete the meaning of the indicia.

23. A patient care and medical alert system as recited in claim 14 wherein said distinct indicia of said message bearing members include areas on the surface of said message bearing member on which variable information is to be removably scribed thereon to complete the meaning of the indicia.
